(19) United States
(12) Patent Application Publication
(10) Pub. No.: US 2012/0144056 A1
(43) Pub. Date: Jun. 7, 2012

(54) Dynamic RTCP Relay

(75) Inventors: Hans Maarten Stokking, Wateringen (NL); Fabian Arthur Walraven, Groningen (NL); Omar Aziz Niamut, Vlaardingen (NL); Mattijs Oskar van Deventer, Leidschendam (NL)

(73) Assignees: NEDERLANDSE ORGANISATIE VOOR TOEGEPAST- NATUURWETENSCHAPPELIJK ONDERZOEK TNO, Delft (NL); KONINKLIJKE KPN N.V., The Hague (NL)

(21) Appl. No.: 13/389,725

(22) PCT Filed: Jul. 30, 2010
(86) PCT No.: PCT/EP2010/061135

§ 371 Date: Feb. 9, 2012

(30) Foreign Application Priority Data
Aug. 12, 2009 (EP) 09010396.1
Oct. 28, 2009 (EP) 09013566.6

(51) Int. Cl. G06F 15/16

(52) U.S. Cl. 709/231

(57) ABSTRACT

A method and a system for dynamically relaying RTCP messages associated with one or more RTP streams is described. Each RTP stream is associated with a media session and with a sender node (MF) and one or more receiver nodes (UE). The method comprises the steps of: assigning at least one control node (MSAS) to at least one RTP stream; providing (4) a receiver node associated with said RTP stream with the address of said control node, said address being provided to said receiver node in a session control protocol message or an HTTP message and being different than the address of the associated sender node; and, said receiver node sending (8) receiver RTCP messages to said control node, using said address comprised in said session control protocol message or HTTP message.

### FIELD OF THE INVENTION

The invention relates to dynamically relaying RTCP messages in a network, though not exclusively, to a method and a system for dynamically relaying RTCP messages in a network, a network element and a user equipment for use in such system and a computer program product for executing the method.

### BACKGROUND OF THE INVENTION

Nowadays the Real Time Transport (RTP) protocol and the associated RTP Control Protocol (RTCP) are widely used for streaming multimedia data over an IP-based network to one or more receivers and for providing control and management information about the media streams respectively. The RTCP protocol is a flexible protocol that may be used for a variety of different purposes. It may be at the core of mechanisms allowing synchronization of multiple source media streams, e.g. lip-sync between video and audio stream, at a single destination. Alternatively it is used for monitoring the Quality of a Service or whole network. Based on RTCP feedback an operator may take appropriate measures to enhance the functioning of a network. An operator may for instance lift network congestion on certain routes by instructing media sources to encode and send media streams in a less bandwidth consuming manner, based on information provided by RTCP messages.

For example, the IP Multi-Media Subsystem (IMS) architecture, which is a unified architecture that supports a wide range of services enabled by the flexibility of Session Initiation Protocol (SIP), uses RTP as the transport protocol. IMS is defined by certain 3GPP and 3GPP2 standards (such as 3GPP TS 22.228, TS 23.218, TS 23.228, TS 24.228, TS 24.229, TS 29.228, TS 29.229, TS 29.328 and TS 23.320 Releases 5-7). Using IMS for IPTV is defined by certain ETSI specifications (such as ETSI TS 182 027 and ETSI TS 183 063). Once a session is established using the Session Initiation Protocol (SIP), the Real Time Transport (RTP) protocol is used for streaming multimedia from a media source or sender to a receiver, optionally using the RTCP protocol between the media sender and the receiver for lip-sync and quality of service information. Similarly, the next generation network (NGN) integrated IPTV architecture as described in TS 183 064 uses HTTP to set up RTP media sessions.

For certain applications, such as inter-destination (group) synchronization, selectively monitoring and content adaptation, it may be advantageous to have a separate active element in the RTCP messages path. For example US2008/0320132 describes a proxy server for intercepting RTCP control messages and measuring the quality of the data transmitted between a sender and a receiver. Furthermore, WO2009/070202 describes an intermediate media processor which monitors the RTCP messages between a media sender and a receiver, and which is capable of intercepting and modifying RTCP control messages and forwarding these modified control messages further to the receiver.

One problem relating to the implementation of such known active elements in a network relates to the fact that these elements first need to receive RTCP messages in order for them to be able to extract information from them. Prior art solutions deal with this problem in different ways.

One solution is to place the active element in a network node, where all RTCP messages and sometimes all RTP media packets pass by and to instruct the active element to intercept and inspect these RTCP packets in order to extract useful information from them. This solution is static confining the use of the active element only to a certain location in the network. Further, such solution does not provide an efficient way of using network resources as in these type of situations usually only a small amount of RTCP traffic is monitored. Finally, such solution limits the possibility of using these active elements for third party services controlled by third parties as is not likely that an operator would allow a third party controlled active element to intercept and inspect all or at least part of the RTCP traffic on its network.

Other solutions for using these active elements in the network use preconfigured media senders, media receivers and active elements to relay the RTCP messages path via the active element. Preconfiguration may alleviate some of the drawbacks listed above, but has the drawback that it is rather static. Once senders, receivers and active elements are preconfigured to relay RTCP messages in a certain way the network is bound to that situation. It does not allow an operator to flexibly choose different active elements for different RTCP based services, or to rapidly change one active element for another when e.g. the active element is out of order or requires an update. In the same manner the preconfigured solutions are very inflexible when the active element is managed and controlled by a third party.

In more general, in the current worldwide IP network environment, many new media senders are connected to the network every second of every day sot that it is almost impossible to keep track of these media sources by adjusting the static configurations in the receivers, the senders and the active elements in order to relay the RTCP messages from the appropriate senders or receivers of media via the appropriate active elements.

Hence, there is a desire in the prior art for methods and systems that provide more flexibility in relaying RTCP messages.

### SUMMARY OF THE INVENTION

It is an object of the invention to reduce or eliminate at least one of the drawbacks known in the prior art and to provide in a first aspect of the invention a method for dynamically relaying RTCP messages RTCP messages associated with one or more RTP streams, wherein each RTP stream is associated with a media session and with a sender node and one or more receiver nodes. The method comprising the steps of: assigning at least one control node to at least one RTP stream; providing a receiver node associated with said RTP stream with the address of said control node, said address being provided to said receiver node in a session control protocol message or an HTTP message and being different than the address of the associated sender node; and, said receiver node sending receiver RTCP messages to said control node, using said address comprised in said session control protocol message or HTTP message. Hence, by exchanging session control protocol message or an HTTP messages between the UE and a control node, e.g. an IPTV SCF in an IMS IPTV system or an CFIA in a NGN integrated IPTV system, relay information, e.g. an address of an active network element and a session identifier such as a Sync Session ID, may be provided to the network elements involved in a media session, e.g. a UE, a media sender and a further network element, thereby allowing media control messages, e.g. RTCP messages, to be relayed through the further network element, which may be an application server such as a Media Synchronization Application Server (MSAS), a (third) party media session monitor, a session border controller, etc.

HTTP provides the advantage that it is simple to implement as in principle it does not require the implementation and the maintenance of a session-control state machine using session control protocol messages (as is the case in SIP). Further, HTTP allows many ways (e.g. URI, SDP, XML, etc.) of transporting parameters and may be used for creating and deleting sessions groups such as Sync Groups.

In one embodiment said method further comprises the step of: providing a group synchronization identifier associated with said RTP stream to said receiver node; and, sending said group synchronization identifier in a receiver RTCP message to said control node.

In a further embodiment method further comprises the step of: said receiver node generating synchronization status information; sending said synchronization status information in a sender RTCP message to said control node, said control node comprising a synchronization function for synchronizing the RTP stream associated with said sender RTCP message with one or more other RTP streams assigned to said control node.

In yet another embodiment said method further comprises the steps of: said synchronization function using said synchronization status information to calculate synchronization settings information; said control node sending said synchronization settings information to said receiver node, said receiver node using said synchronization settings information to instruct a delay buffer associated with said receiver node.

In one embodiment the method further comprises the steps of: providing said sender node associated with said RTP stream with the address of said control node, said address being provided to said sender node in a session control protocol message or an HTTP message; said sender node sending sender RTCP messages to said control node, using said address comprised in said session control protocol message.

In another embodiment said method further comprises the steps of: the control node receiving one or more receiver RTCP messages and one or more sender RTCP messages and associating a receiving RTCP message with a sender RTCP when the RTP session identifier, preferably the SSRC, in said RTCP messages are identical; the control node sending a receiver RTCP message to the address from which an associated sender RTCP message originates and/or sending a sender RTCP message to the address from which an associated receiver RTCP message originates.

In one variant at least one of said receiver RTCP messages comprises synchronization status information, said method further comprises the steps of: removing said synchronization status information from said receiver RTCP message; and, sending said receiver control message to said associated sender node.

In a further variant said method further comprises the steps of: said synchronization function providing synchronization settings information; and, sending said synchronization settings information in a sender RTCP message to said receiver node.

In yet a further variant the method further comprises the step of: at least one sender node multicasting at least one of said RTP streams and associated sender RTCP messages to one or more receiver nodes.

In a further embodiment the method further comprises the step of: the receiver node sending at least one of said RTCP messages to said control node.

In one embodiment the method comprises the steps of: sending a request for the control node to join the member group associated with said multicast or providing an unicast connection between the sender node and the control node for providing sender RTCP messages to said control node.

In another embodiment the method comprising the steps of: the control node receiving one or more receiver RTCP messages and one or more sender RTCP messages and associating a receiving RTCP message with a sender RTCP when the RTP session identifier, preferably the SSRC, in said RTCP messages are identical; the control node sending a receiver RTCP message to the address from which an associated sender RTCP message originates and/or sending a sender RTCP message to the address from which an associated receiver RTCP message originates.

In yet another embodiment said session description protocol is the SIP protocol or the RTSP protocol. In a further variant said control node is a synchronization server for synchronizing a group of receiver nodes or wherein said control node comprises one or more functions for monitoring information, in particular quality of service, data traffic information and/or data management information, in said control messages and/or for modifying information in said control messages according to one or more predetermined rules.

In another aspect the invention relates to a system for dynamically relaying RTCP messages, the system comprising:

a control node for receiving one or more of receiver RTCP messages generated by one or more receiver nodes and/or sender RTCP messages generated by one or more sender nodes;
a relay control function associated with said control node, said control function being configured to provide a receiver node and/or sender node associated with said RTP stream with the address of said control node, said address being provided to said receiver and/or sender node in a session control protocol message at least one receiver node configured to send RTCP messages to said control node, using said address comprised in said session control protocol message.

In one variant the system comprises: at least one sender node configured to send RTCP messages to said control node, using said address comprised in said session control protocol message or an HTTP message; wherein said control node further comprises: at least one input for receiving receiver RTCP messages originating from one or more receiver nodes and/or sender RTCP messages originating from one or more sender nodes; a mapping function for associating a receiving RTCP message with a sender RTCP when the RTP session identifier, preferably the SSRC, in said RTCP messages are identical;

at least one output for sending a receiver RTCP message to the address from which an associated sender RTCP message originates and/or sending a sender RTCP message to the address from which an associated receiver RTCP message originates.

In a further variant the said receiver node is configured to insert synchronization status information in said receiver RTCP messages.

In one variant system said system further comprises: a synchronization function associated with said control node, said function being configured to receive synchronization status information sent by one or more receiver nodes in one or more receiver RTCP messages to said control node and to calculate on the basis of said synchronization status information synchronization settings information for said one or more receiver nodes, said synchronization settings information allowing the one or more receiver nodes to time-delay at least one RTP stream.

In another aspect the invention relates to a receiver node for use in a system according as described above, the receiver node comprising: a relay client configured for receiving a session control protocol message or an HTTP message comprising the address of a control node and sending receiver RTCP messages generated by said receiver node to said control node, using said address comprised in said session control protocol message; and, a sync client configured for generating synchronization status information, for inserting said synchronization status information in a receiver RTCP message and sending said receiver RTCP message to said control node.

The invention also relates to a control node for use in a system as described above, the control node comprising:

at least an input for receiving receiver RTCP messages originating from one or more receiver nodes and/or sender RTCP messages originating from one or more sender nodes;
a mapping function for associating a receiving RTCP message with a sender RTCP when the RTP session identifier, preferably the SSRC, in said RTCP messages are identical;
at least one output for sending a receiver RTCP message to the address from which an associated sender RTCP message originates and/or sending a sender RTCP message to the address from which an associated receiver RTCP message originates;
and, optionally, a sync function configured for receiving synchronization status information sent by one or more receiver nodes in one or more receiver RTCP messages to said control node and for calculating on the basis of said synchronization status information synchronization settings information for said one or more receiver nodes, said synchronization settings information allowing the one or more receiver nodes to time-delay at least one RTP stream.

The invention further relates to a computer program product comprising software code portions configured for, when run in the memory of one or more network nodes, executing the method steps as described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 depicts a system according to one embodiment of the invention.

FIG. 2 depicts a message flow diagram of a method according to one embodiment of the invention.

FIG. 3 depicts an alternative message flow diagram of a method according to one embodiment of the invention.

FIG. 4 illustrates a possible definition for an RTCP XR report block according to an aspect of the invention

FIG. 5 illustrates a possible definition for an RTCP XR report block according to a further aspect of the invention.

FIG. 6 depicts another message flow according to a further embodiment of the invention.

FIG. 7 illustrates a message flow for an embodiment according to the invention in a IP multicast scenario.

FIG. 8 illustrates a possible definition for an RTCP XR report block according to a further aspect of the invention.

FIG. 9 depicts another flow according to a further embodiment of the invention.

FIG. 10 depicts a further system according to an embodiment of the invention.

FIG. 11 depicts a message flow according to one embodiment of the invention.

FIG. 12 depicts a flow according in a IP multicast scenario according to a further embodiment of the invention.

### DETAILED DESCRIPTION

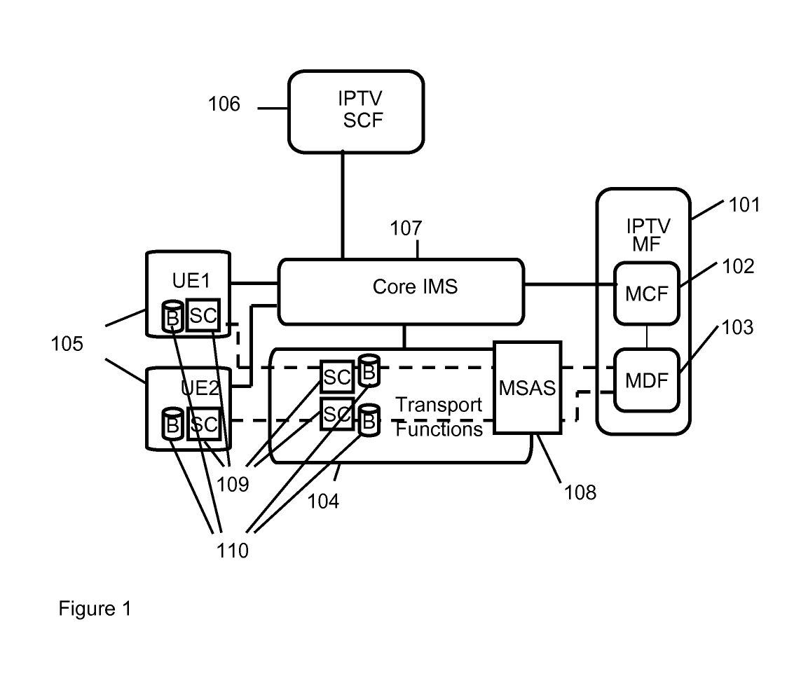

FIG. 1 illustrates an example of an IMS-based IPTV system 100 as defined by ETSI TISPAN TS 183 063 and TS 182 027. The system is adapted for dynamically relaying RTCP messages according to a first embodiment of the invention. The system comprises an IMS core 107 comprising a set of Call/Session Control Functions (CSCF): e.g. a Proxy-CSCF (P-CSCF), an Interrogating-CSCF (I-CSCF) and a Serving-CSCF (S-CSCF). The IMS core is connected to User Equipment (UE) 105, IPTV service control functions (SCF) 106 for controlling IPTV services in the network (e.g. a broadcast SCF, a Content-on-Demand SCF, etc.) and to Media Functions (MF) 101 comprising Media Control Functions (MCF)102 and Media Delivery Functions (MDF)103 to control the delivery of media content and control packets via Transport Functions (TF) 104 to the User Equipment.

The architecture from TS 182 027 is extended with a Media Synchronization Application Server (MSAS) 108, which is arranged to execute inter-destination synchronization functions. Inter-destination media synchronization means that the presentation of certain media in time is the same at different destinations of that media, e.g. the same video fragment or audio sample is played at the same time at the different destinations. The synchronization activities at the user equipment or network nodes may be executed using buffers 110 at Synchronization Client (SC) 109 locations. The Synchronization Clients co-operate with the MSAS and coordinate the buffer activities by instructing the buffers to delay received media streams.

The IPTV system in FIG. 1 uses the Session Initiation Protocol (SIP) to set up and control sessions between user terminals or user terminals and the applications servers comprising the SCFs and MFs. The Session Description Protocol (SDP) carried by SIP signaling is used to describe and negotiate the media components in the session. Further, the Real Time Streaming Protocol (RTSP) is used for media control providing e.g. broadcast trick modes, Content-on-Demand (CoD) and Network Personal Video Recorder (NPVR) and the Real Time Transport Protocol (RTP) is used for media transport.

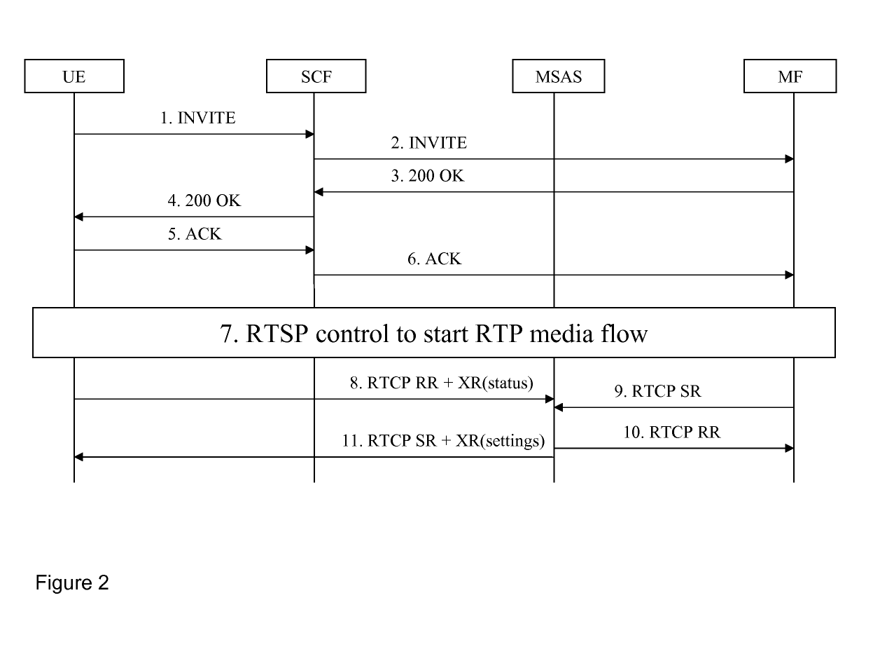

FIG. 2 depicts a protocol flow according to an exemplary embodiment of the invention for a UE receiving an unicast Content on Demand media stream. In this embodiment the user of a UE wants to receive Content on Demand (CoD) and view it in a synchronized way together with one or more users of other UE's. The play out time of the CoD RTP stream of the particular UE needs therefore to be synchronized with the play-out times of the other UE's receiving other related CoD RTP streams (e.g. the same movie).

In this example, the SIP protocol is used for the session set-up according to ETSI TS 183 063 RTSP method 1. In a first step the UE sends an initial SIP INVITE message to the SCF. This SIP INVITE comprises a parameter called a SyncGroupId, which identifies the synchronization group the specific UE belongs to. In this example it is assumed that the SyncGroupId is already known to the UE. However other implementations are also possible. The SyncGroupId may for instance also be assigned by the SCF during the session set up and be communicated for the first time to the UE in the SIP 200 OK message of step 4.

A synchronization group is a group of UE's that require to be synchronized with respect to one or more designated media streams. An example of such a group may be two UE's belonging to two different users on two different locations requesting to watch the same Content on Demand (movie) together in a synchronized manner.

The SyncGroupId parameter may be implemented as a Session Description Protocol (SDP) session level attribute, e.g. a=RTCP-xr:sync-group=<value>. In one embodiment the RTCP-xr attribute field known from IETF RFC 3611 may be used, since it is intended to communicate information about application specific extensions of the RTCP protocol. The SCF receives the set-up request and may add the user to the synchronization group. The SCF may then select an appropriate MSAS for this synchronization session. In step 2 a SIP INVITE message is sent to the appropriate MF containing both the SyncGroupId and the network address of the selected MSAS. This MSAS address may be comprised in another session level attribute, e.g. using the RTCP attribute in SDP from IETF RFC 3605. The RTCP attribute sent to the MF may also comprise a port number. The MF may use the information from the RTCP attribute that is contained in the SIP message as new address instructions to sent RTCP messages regarding this session to. In case no alternative port number is communicated in the SIP INVITE message, the MF may use a default RTCP port number for sending RTCP messages, according to IETF RFC 3550, namely taking the RTP port number and adding 1.

Upon receipt of the session set up (SIP INVITE) message, the MF assigns a SSRC identifier to the RTP stream or streams requested. In step 3 the MF sends a SIP 200 OK response to the SIP INVITE, which includes both the SyncGroupId and the newly generated SSRC(s) identifier(s) for the media stream(s). The SSRC(s) uniquely identifying the media stream(s) may be sent using a media level attribute in SDP according to IETF RFC 5576. In step 4 the SCF sends a SIP 200 OK message to the UE, which responds with a final acknowledgement. This SIP 200 OK message contains the SSRC(s) of the requested media stream(s), and the MSAS address and, optionally, one or more alternative RTCP port numbers. In addition, the SIP message may contain the newly assigned or agreed SyncGroupId. The UE may use the received MSAS address and alternative port information as new address instructions to sent RTCP messages regarding this session to. More in particular, it may use these new address instructions to send synchronization status information via RTCP to a MSAS that has a different address than the source (sender) address of the media stream(s).

In case no alternative port number is communicated in the SIP OK message, the UE may use a default RTCP port number for sending RTCP messages, according to IETF RFC 3550, namely taking the RTP port number and adding 1. In step 5 and 6 both the UE and SCF respond to the received SIP OK messages with a SIP ACK message.

In step 7 the RTSP control is used to set-up the actual media streams, and the media streams start streaming from MF to UE. Ways of setting up the media stream are described in ETSI TS 183 063. In step 8, during media stream delivery, the UE may include synchronization status information and SyncGroupId to its RTCP Receiver Reports (RTCP RR). This may for example be done using RTCP eXtended Reports (RTCP XR) or for example in the form of SDES PRIV items according to IETF RFC 3550. The UE sends this information as RTCP messages to the MSAS.

In step 9 the MF sends its RTCP Sender Reports (RTCP SRs) as RTCP messages to the MSAS. The RTCP messages of both the sending media source (MF) and the receiving media destination (UE), that are received by the MSAS, both have a common media stream identifier (SSRC).

The MSAS may now forward the RTCP messages received from the UE to the MF and RTCP messages received from the MF to the UE, by matching the SSRC in each of the reports it receives. The SSRC identifier is unique for a given RTP stream, so RTCP messages from a media sender (MF) and from a media receiver (UE) containing the same SSRC identifier may be matched. In steps 10 and 11a received media Sender Report RTCP message is sent to the IP address from which the matched media Receiver Report RTCP message originates, and vice versa. The MSAS may calculate settings instructions for each of the UE's involved in a synchronization session, using synchronization status information from RTCP messages received from multiple UEs that have the same SyncGroupID. These setting instructions that may comprise delay information for each UE in the synchronization group may be included in special RTCP XR's and sent as RTCP messages to the respective UE's using the mechanism as described above.

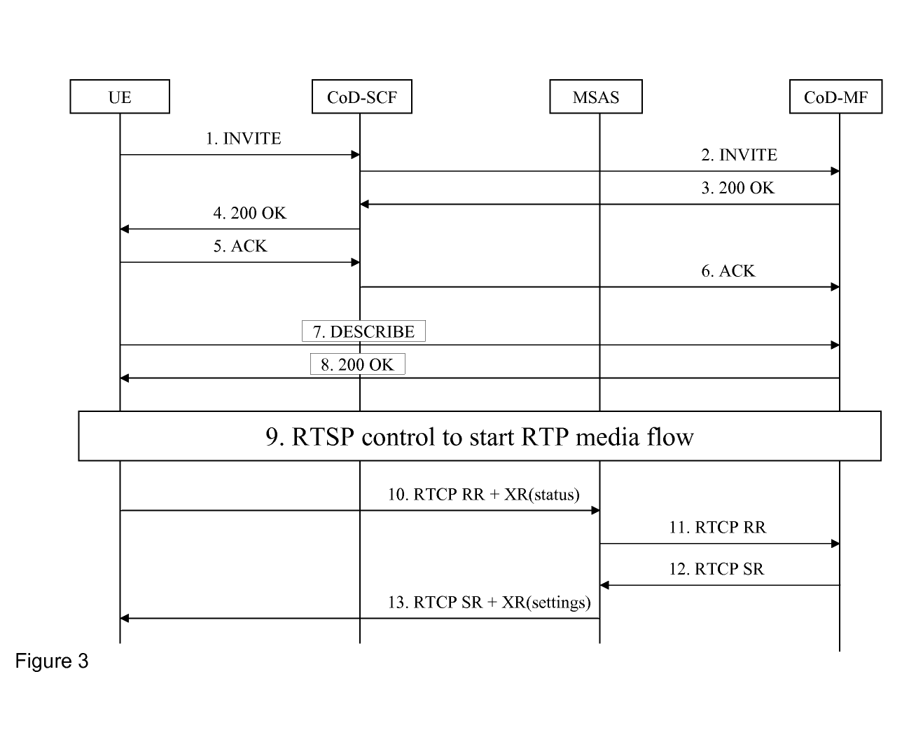

FIG. 3 illustrates another exemplary message flow according to an embodiment of the invention. In this embodiment, the media session is set-up using a combination of SIP and RTSP, according to ETSI TS 183 063 RTSP method 2. Steps 1 to 6 are similar to the steps 1 to 6 of the message flow depicted in FIG. 2, and therefore no further elaborated in detail. The only difference between the message flows with regard to steps 1 to 6 in FIGS. 2 and 3 is the absence of the SSRC identifier in the SIP OK messages (step 3 and 4) of the method illustrated by FIG. 3. As a result the subsequent steps the message flow in FIG. 3 slightly differs from those in FIG. 2.

According to ETSI TS 183 063 RTSP method 2, media level attributes are set-up (negotiated/exchanged) using RTSP DESCRIBE messages (instead of using SIP INVITE). Since the SSRC identifier generated and assigned by the MF is a media level attribute, unique to a RTP media stream, the MF will respond to the SIP INVITE with a SIP 200 OK containing the SyncGroupId and the MSAS address, but not the SSRC identifier. After the SIP session set-up of the RTSP channel, the UE uses the RTSP DESCRIBE message to set up the actual media streams. When the MF receives this DESCRIBE message in step 7, it generates and assigns the SSRC identifier and adds this identifier to a RTSP 200 OK message that is sent in step 8 to the UE in response to the DESCRIBE message. This may be done in the SDP description of the media contained in the RTSP 200 OK message, using the media level attribute in SDP according to IETF RFC 5576. From the start of the media flow, the subsequent steps, including the RTCP relay mechanism, are similar in the embodiments illustrated by FIGS. 2 and 3 respectively.

In general, synchronization status information may be best described as timing information on media reception at each synchronization client (SC). A synchronization client (SC) may be located in User Equipment (UE) or any other point in a network where the receipt of media packets may be measured. A SC co-operates with a Synchronization Server (also referred to as MSAS) to synchronize streams received at different receivers or to synchronize different streams received at the same receiver. A receiver may be the end destination or intermediate destination of a media stream. The respective sampling points for determine synchronization status information may also be referred as synchronization points.

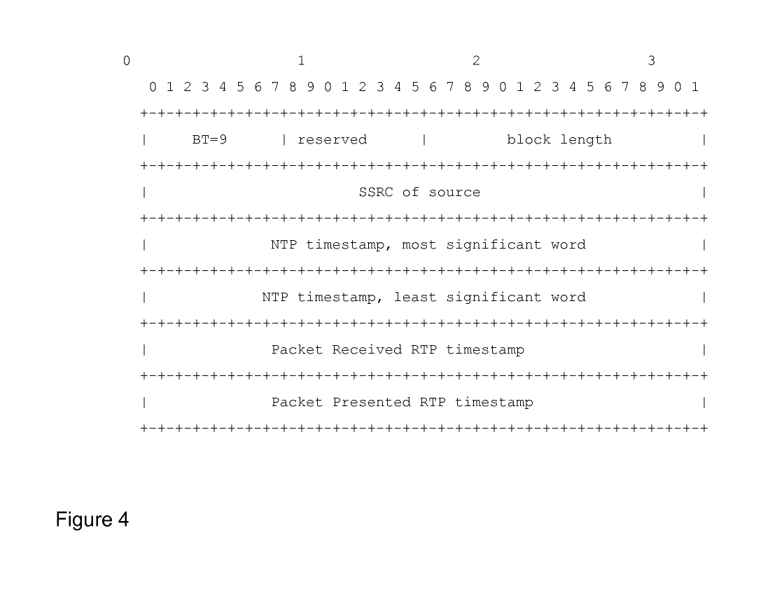

FIG. 4 illustrates a possible definition for an RTCP XR report block for carrying synchronization status information. The first line contains header information, comprising a defined Block Type defining the RTCP XR report block, a reserved space and the block length. The second line contains the SSRC identifier of the RTP media stream, on which the RTCP report block reports. The third line contains the NTP timestamp of the receiver of the RTP stream. This NTP timestamp requires 64 bits and is thus split in a most and least significant word. Finally, the RTP timestamp of the received packet at this NTP time (stamp), and the RTP timestamp of the displayed (played-out/presented) packet at this NTP time is given. Group synchronization of receivers may be performed based on packet receipt time stamps, or on actual packet display/presentation timestamps, depending on the configuration of the synchronization server. Since different types of UE's may show different delays between their receiving interface and their displaying interface it may be preferred to use the actual display/presentation time stamps for a maximum user experience. However, since not all user equipment in heterogeneous network environments may be able to report on actual display times, preferably (although not necessarily) both packet receipt and packet displayed timestamps are incorporated in a RTCP XR report sent by the UE (receiver) to the MSAS.

In general, Synchronization settings instruction(s) may be best described as instructions (or indication) from which a Synchronization Client (SC) may directly or indirectly derive how much it should delay a media stream. A media stream may for example be a broadcast (BC) channel, a unicast or multicast (channel). The Synchronization Client may then further instruct an appropriate buffer to delay the relevant media stream.

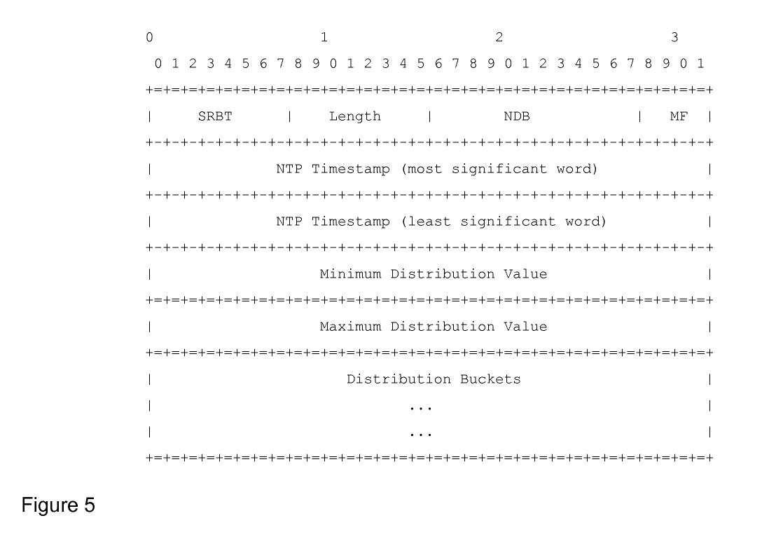

FIG. 5 illustrates a possible definition for an RTCP XR report block for carrying synchronization settings instructions. The format of a receiver summary information packet from IETF Internet Draft draft-ietf-avt-rtcpssm-18 is used here. The RTCP XR block in this example reports on an NTP timestamp on the basis of which all RTP timestamps are calculated. It contains the NTP timestamp on which the RTP timestamps of all UEs are mapped, and the RTP timestamp minimum and maximum value of all the UEs in the synchronization group at this particular time. The report may contain a multiple of RTP timestamps, although for the purpose of inter-destination synchronization only the minimum RTP timestamp (corresponding to the most delayed stream) is needed. From this information (synchronization settings instructions) each synchronization client is capable of calculating how much it should delay its stream with respect to the most delayed stream.

As an alternative, the MSAS may simply send an arbitrarily value (lower than the lowest measured RTP timestamp that it received from all SC's), which the SC's should use for synchronizing their streams. This would moderate natural delay fluctuations in the network and would prevent the SC's from having to re-adjust the buffers too often.

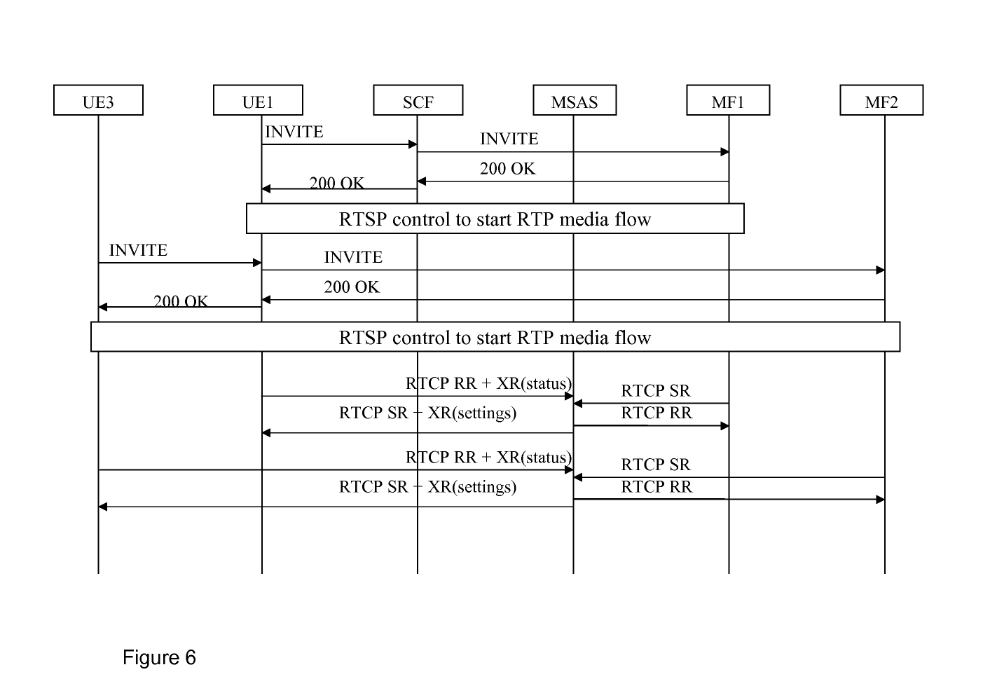

FIG. 6 depicts another exemplary flow according to an embodiment of the invention. The message flow is similar for the media session set-up and synchronization mechanism as the flow from FIG. 2, except that the embodiment depicted in FIG. 6 is illustrative for a situation wherein 2 UE's (UE1 and UE2) each receive a media stream from a different Media Source (MF1 and MF2), and wherein it is required to synchronize both media streams.

In this embodiment the SCF assigns the same MSAS (MSAS address and optionally RTCP port number) to both separate sessions during the session set-ups. This causes both UE1 and UE2 and MF1 and MF2 to sent their RTCP messages to the same MSAS. Because the SSRC identifier for the media stream from MF1 to UE1 differs from the SSRC identifier for the media stream from MF2 to UE2, the MSAS is able to match the RTCP messages (and the reports contained therein) it receives from MF1 with RTCP messages it receives from UE1, and likewise RTCP messages received from MF2 with RTCP messages received from UE2. Subsequently the MSAS may forward the RTCP messages using mechanisms already described herein, to the correct UE's (media stream receivers) and MF's (media stream senders).

The MSAS may calculate or determine delay settings instructions to synchronize the media stream arriving at (or displayed/presented by) UE1 with the media stream arriving at (or displayed/presented by) UE2, based on the relevant synchronization settings information extracted from the received RTCP messages from UE1 and UE2. The MSAS may match the synchronization status information concerning the RTP stream sent to UE1 to the synchronization status information concerning the stream sent to UE2, because both UE1 and UE2 report or have reported the same SyncGroupId parameter to the MSAS in at least one of their RTCP messages sent to the MSAS. The MSAS may, as described before, add the delay settings instructions to the RTCP messages received from the MF's, prior to sending them to the respective UE's.

The synchronization of different media streams from different sources to different UE's requires that the MF1 and MF2 either use the same RTP timestamps instead of a random offset, when playing out the respective media streams, or that the correlation between the RTP timestamps is known a priori or provided to the MSAS before the MSAS starts calculating or determining the delay settings instructions.

Normally during an IP multicast, both RTP and RTCP packets are sent using a multicast mechanism. Both senders and receivers of media sent their RTCP reports to the same multicast address as the media traffic, but use the next higher port number compared to the RTP traffic. In the Internet Draft draft-ietf-avt-rtcpssm-18 a system is described for use in single source multicast (SSM), where media is streamed only from one source to many receivers. In SSM the receivers of media should not normally sent (RTCP) to the same multicast address. This is in particular the case in IPTV multicasts with many viewers, in order not to flood the allocated network resources with non-content traffic (e.g. RTCP control messages), where they may not be needed. The draft proposes the use of an unicast mechanism for the sending of RTCP reports by receivers. They may unicast their RTCP reports to a so-called feedback target. Furthermore, a distribution source is introduced that receives media from senders and distributes this media to receivers. Likewise it takes care of the distribution of RTCP messages amongst senders and receivers.

The feedback target may be separate from the distribution source, but the transport address of the distribution source has to be configured in the feedback target, so the feedback target is able to relay RTCP messages to the distribution source. Likewise, according to this document, the receivers need to be preconfigured with a feedback target address, so they know a priori where to send their RTCP messages to. In other words, the whole relay mechanism of RTCP messages generated by receivers of media, is static (preconfigured) and requires the presence of a new entity called a distribution source in the network.

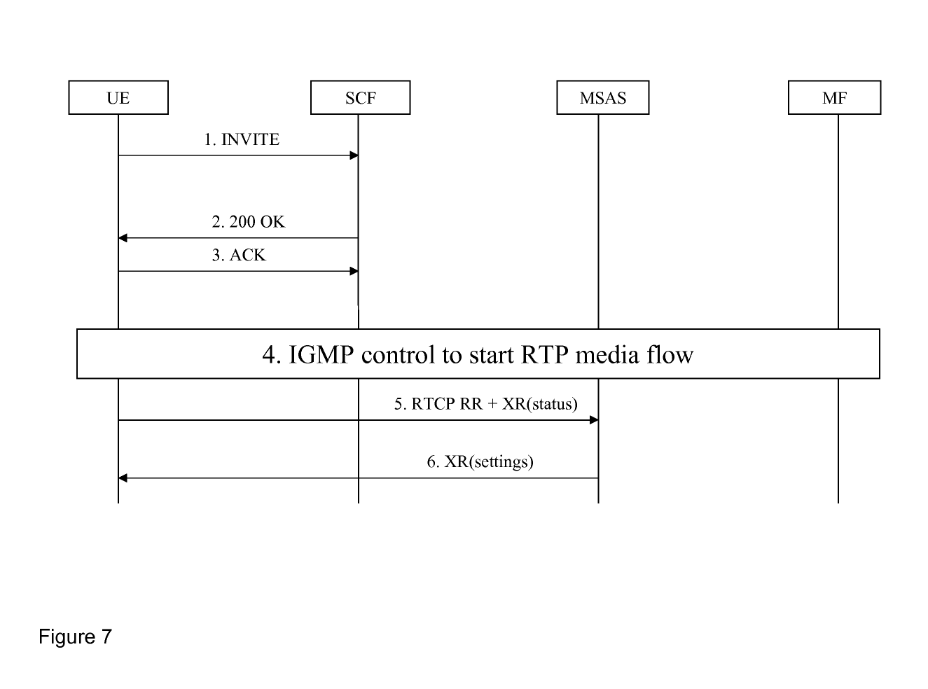

FIG. 7 illustrates a message flow for an exemplary embodiment according to the invention in a IP multicast scenario. This embodiment relates to the inter-destination synchronization of receivers (UE's) subscribed to a multicast channel. This scenario may be applicable when for example two users would like to watch the same live content (for instance a multi-casted soccermatch) in a synchronized manner on different UE's on different locations. They may have a continuous chat session or an open telephone line, enjoying the game together, without running the risk that one user sees a goal seconds before the other does.

It is envisaged that the invention elaborated in this document may be used as the basis for an additional ‘watching apart together’ synchronization service, that may be delivered by a third party, different from the content provider. An enabling embodiment according to the invention, suitable for this scenario, is described below. In this embodiment the synchronization service is started during the session set-up prior to a user joining a multicast.

According to ETSI TS 183 063, when a receiver wishes to join a multicast, it first has to set up a session with the appropriate SCF. It may do so by using SIP messages, according to steps 1 to 3 of FIG. 7. In this embodiment the SIP INVITE sent by the UE in step 1 already contains a parameter called SyncGroupId, which identifies the synchronization group the UE belongs to. Alternatively the SyncGroupId may be assigned by the SCF and communicated in step 2 to the UE.

An exemplary implementation of how the SyncGroupId may be packaged uses an Session Description Protocol (SDP) session level attribute, e.g. a=RTCP-xr:sync-group=<value>. The SCF receives the set-up request and may add the user to the appropriate synchronization group. The SCF may then select an appropriate MSAS for this synchronization session and send the MSAS transport address in the reply to the INVITE, i.e. in the SIP 200 OK message of step 2. This MSAS address may e.g. be contained in another session level attribute, e.g. using the RTCP attribute in SDP from IETF RFC 3605. The port number may be chosen in the same manner as regular RTCP port numbers are chosen according to IETF RFC 3550, namely taking the RTP port number and adding 1.

Next, in step 4, the media flow(s) are set-up using e.g. IGMP to subscribe to the particular media stream(s). The UE, in step 5, may now send RTCP messages comprising synchronisation status information directly to the MSAS, using the received MSAS address (RTCP relay address) from the SCF. These RTCP messages may be Receiver Report messages with the appropriate extensions for sending the synchronization status information and SyncGroupId. In this embodiment all multicast receivers receive the same multicast stream containing the same RTP timestamps and therefore the MSAS does not need any RTCP sender report information to calculate synchronization instructions. Likewise the MSAS does not require the sender reports for determining to which media sender the received RTCP messages from the UE's need to be sent to, since the media sender in a SSM configuration in many cases does not receive any RTCP messages from UE's (media receivers) at all. No matching between the various RTCP messages needs to be made in this embodiment and therefore the SSRC comprised in the RTCP messages is not used either by the MSAS. Instead, as shown in step 6, the MSAS may just send its synchronization settings instructions, using a unicast RTCP message (e.g. an RTCP eXtended Report containing such settings) to the appropriate UE, by simply using the originating addresses of the previously received RTCP messages.

The MSAS may require Sender reports for synchronization in a multicast environment in specific cases. For example because the different receivers watch the same content but in a different stream, e.g. an HighDefinition stream on one multicast channel versus an SD stream on another multicast channel. These sender reports may be obtained by the MSAS in several different ways.

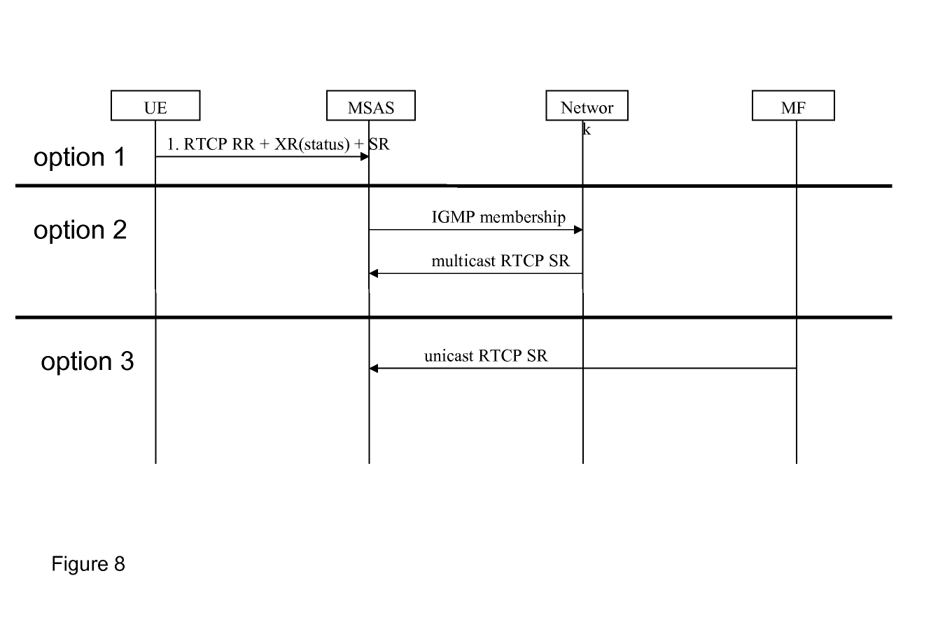

FIG. 8 exemplifies three embodiments for receiving RTCP sender reports by an MSAS. In a first embodiment (option 1), the receiver of a multicast adds the sender report to receiver reports that it sends as RTCP messages to the MSAS. All multicast receivers receive the sender reports on the same multicast address but on different port numbers. They may sent a copy of these sender reports to the MSAS.

In a second embodiment (option 2), the MSAS to subscribe to the multicast channel. The MSAS sends the appropriate IGMP message, and becomes a member of the multicast group. The MSAS will then receive all messages sent to this group, including the RTCP messages. Since the granularity of multicast traffic is only on address, and not on port number, this would mean that the MSAS will also receive all media traffic. To prevent this, the network preferably filters out the media traffic, and only forwards the RTCP traffic. This is rather easily conceived, since RTP should use only even port numbers and RTCP only odd port numbers in standard configurations.

In a third embodiment (option 3) the media source (the Media Function MF) sends copies of its sender reports to the MSAS, using a unicast mechanism.

If the MSAS is able to receive the sender reports, it no longer requires the configuration of the transport address of the media source to be able to forward the receiver reports. Instead it may use the same dynamic mechanism of matching the SSRC from the RTCP messages from media receivers with the SSRC from the RTCP messages received from the senders, using the mechanism elaborated above to determine the correct transport address of the media senders.

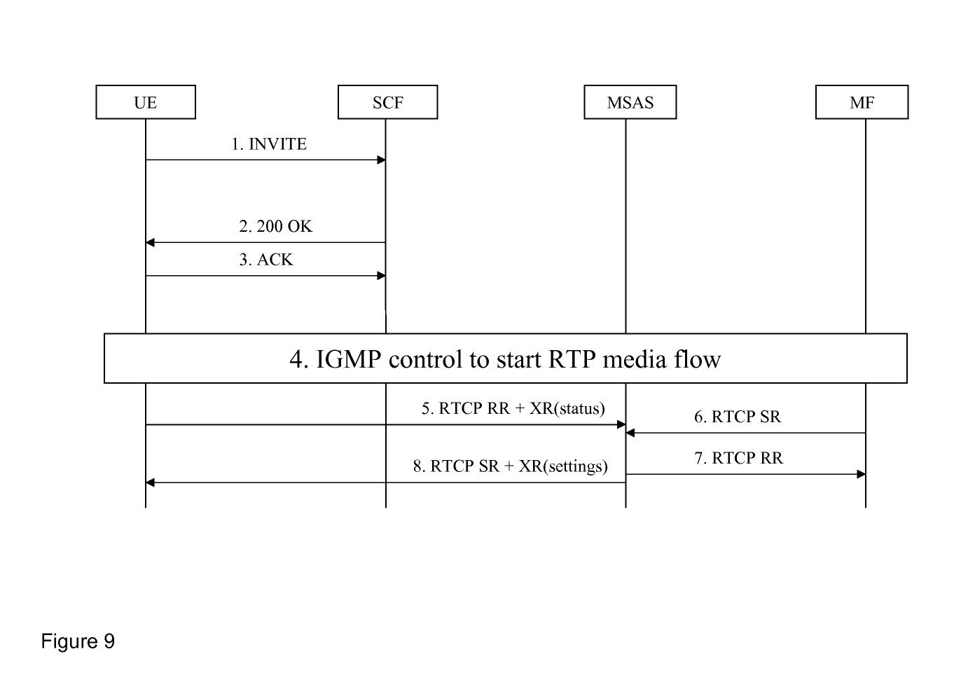

A message flow according to this alternative embodiment is further illustrated in FIG. 9. As an example the RTCP RR (Receiver Report) message received in step 5 by the MSAS from a media receiver (UE) is matched by its SSRC to the appropriate RTCP SR (Sender Report) message that is received in step 6 by the MSAS from a media sender (MF). In step 7, based on the matching, the MSAS forwards the RTCP RR message to the MF. This dynamic relay mechanism makes it no longer necessary to pre-configure the MSAS with a transport address of the media sender. It thus provides for a very flexible and elegant method of relaying RTCP messages.

It is noted that in the embodiment illustrated in FIG. 9 some configuration may be needed to enable the receipt of RTCP messages from the media sender by the MSAS. If the MSAS for example requires subscription to a multicast address (e.g. to obtain said RTCP messages), it needs to be preconfigured with this address or obtain it through some other mechanism. If the media sender (MF) needs to send a copy of its multi-casted RTCP messages using a unicast mechanism, it needs the unicast address of the MSAS. If the receiver forwards the RTCP media sender messages to the MSAS, then the MSAS will not learn the transport address of the MF, so the MSAS cannot forward receiver reports to the media sender in that case. Of course, the receiver may include the transport address of the media sender (MF) in its RTCP messages, but this would require to define another extension to RTCP.

FIG. 10 depicts a schematic of another embodiment of the invention. In particular, FIG. 10 depicts a schematic of a next generation network (NGN) integrated IPTV system as defined by ETSI TISPAN TS 183 064. The general layout of the architecture of such NGN integrated IPTV system is almost similar to the IMS system as described with reference to FIG. 1 and is adapted for dynamically relaying RTCP messages according to a further embodiment of the invention.

The NGN integrated IPTV system comprises an IPTV-Core (IPTV-C) 1007 and an HTTP-based Customer Facing IPTV applications (CFIA) 1006. The IPTV-C is configured to check if User Equipment UE1,UE2 1005 connected to the system has been authorized by the CFIA and to provide appropriate selection of the Media Functions (MF) 1001 comprising Media Control Functions (MCF)1002 and Media Delivery Functions (MDF) 1003 for controlling the delivery of media content and control packets via Transport Functions (TF) 1004 to the User Equipment.

Similar to the IMS system in FIG. 1, the NGN integrated IPTV system is extended with one or more Media Synchronization Application Servers (MSAS) 1008, which are arranged to execute inter-destination synchronization functions. The synchronization activities at the user equipment or network nodes may be executed using buffers 1010 at Synchronization Client (SC) 1009 locations.

The CFIA is configured to maintain the active Sync Groups associated with the different inter-destination synchronized services to which an UE connected to the system may connect to. Further, the CFIA may be connected to a Service Discovery & Selection (SD&S) function (not shown) providing the CFIA with information on said synchronized services, e.g. with the help of information from an Electronic Programming Guide (EPG).

The system uses the Real Time Streaming Protocol (RTSP) for media control and the Real Time Transport Protocol (RTP) for media transport. However, in contrast with the IPTV system in FIG. 1, the NGN integrated IPTV system uses the Hypertext Transfer Protocol (HTTP) protocol to set up (RTP) media sessions between user terminals or user terminals and the applications servers comprising the MFs. As a stateless protocol HTTP provides the advantage that it is simple to implement as in principle it does not require the implementation and the maintenance of a session-control state machine (as is the case with statefull protocols such as SIP). Further, HTTP allows many ways (e.g. URI, SDP, XML, etc.) of transporting parameters and may be used for creating and deleting Sync Groups. Implementations and associated advantages are described hereunder in more detail with reference to FIGS. 11 and 12.

FIG. 11 depicts a protocol flow 1100 according to an exemplary embodiment of the invention for a UE receiving an unicast Content on Demand media stream. Similar to the protocol flow in FIG. 2, the protocol flow in FIG. 11 relates to a user of a UE requesting Content on Demand (CoD) which is synchronized for viewing the content together with one or more users of other UE's.

In this embodiment the session set-up is achieved using HTTP. In a first step 1, the UE sends an HTTP GET message comprising a SyncGroupId identifying the synchronization group the specific UE belongs to the CFIA. The SyncGroupId may already be known to the UE. Alternatively, the SyncGroupId may for instance created by the UE during session set-up.

The SyncGroupId parameter may be conveyed in the HTTP message using XML, SDP, SOAP or any other suitable protocol. Suitable implementations will be described hereunder. The CFIA receives the HTTP GET message and may add the user on the basis of the SyncGroupId to the appropriate synchronization group. The CFIA may then select an appropriate MSAS for this synchronization session and associate an address to the selected MSAS.

In step 2 an HTTP GET message is sent to the appropriate MF containing both the SyncGroupId and the network address of the selected MSAS. This MSAS address may be conveyed in the HTTP message using XML, SDP, SOAP or in another suitable embedded session level attribute, e.g. the RTCP attribute in SDP from IETF RFC 3605. The HTTP message sent to the MF may also comprise a port number.

The MF may retrieve the information in the HTTP message and may regard the address and port information contained therein as an instruction to send RTCP messages regarding that session to that address.

Upon receipt of the HTTP message the MF assigns a SSRC identifier to the RTP stream or streams requested. In step 3 the MF sends an HTTP 200 OK message back to the CFIA, wherein the 200 OK message both comprises the SyncGroupId and the newly generated SSRC(s) identifier(s) for the media stream(s).

In step 4 the CFIA may send a 200 OK message to the UE, who responds with a final acknowledgement. This 200 OK message contains the SSRC(s) of the requested media stream(s), and the MSAS address and optionally alternative RTCP port number. In addition, this HTTP message may contain the newly assigned or agreed SyncGroupId. The UE may regard the received MSAS address and alternative port information as an instruction to send RTCP messages regarding this session to that address. In more particular, it may use these new address instructions to send synchronization status information through RTCP messages to a MSAS that has a different address than the address of the source (sender) of the media stream(s).

Thereafter in steps 5-9, the RTSP control is used to set-up the actual media streams, and the media streams start streaming from MF to UE using RTCP Receiver Reports (RTCP RR) and RTCP eXtended Reports (RTCP XR). These steps are identical to the process as described in FIG. 2 and described in more detail in TS 183 063.

In a similar way HTTP may be used for an UE requesting to join a multicast by first setting up an HTTP session with the CFIA and for an UE This process is depicted in FIG. 12 and is similar to the SIP-based message flow in FIG. 7.

HTTP may convey parameters, e.g. the SyncGroupId, the address of the MSAS, etc. using different protocols. In one embodiment these parameters may be conveyed using the Extensible Markup Language protocol (XML). For example, the http messages for sending parameters between a UE and the CFIA may comprise an XML body. For example a UE may request synchronization information from the CFIA using the following HTTP request:

GET http://cfia.etsi.org/syncgroup/?SyncGroupId=217a5bd0 HTTP/1.1

### User-Agent: IPTVClient/1.0

Alternatively, the URL may have another format, e.g. http://cfia.etsi.org/syncgroup/217a5bd0 HTTP/1.1. In response, the CFIA may send the requested information through a HTTP response comprising an XML body with the parameters associaded with SyncGroupId 217a5bd0:

HTTP/1.1 200 OK
Server: CFIA/1.0
Content-Type: application/vnd.etsi.iptvsyncgroup+xml
Content-Length: 35
<?xml version=“1.0” ?>
<syncgroup id=“217a5bd0”>
<rtcp ssrc=“AF” recv=“192.168.1.100:1234” />
</syncgroup>

In this example the XML body identifies the SSRC associated with this synchronization session and the IP address and the port number of the MSAS (recv). An XML schema associated with the XML body may look as follows:

```
<?xml version=“1.0” ?>
<xs:schema xmlns:xs=“http://www.w3.org/2001/XMLSchema”>
<xs:element name=“syncgroup”>
  <xs:complexType>
    <xs:sequence>
      <xs:element name=“participant”>
        <xs:complexType>
          <xs:attribute name=“id” type=“xs:string”/>
        </xs:complexType>
      </xs:element>
      <xs:element name=“rtcp”>
        <xs:complexType>
          <xs:attribute name=“ssrc” type=“xs:string”/>
          <xs:attribute name=“recv” type=“xs:string”/>
        </xs:complexType>
      </xs:element>
      <xs:attribute name=“id” type=“xs:string”/>
    <xs:sequence>
  </xs:complexType>
</xs:element>
</xs:schema>
```

It is appreciated that many variations of this XML scheme may be possible in order to obtain identical or similar XML bodies.

In another embodiment, the Simple Object Access Protocol (SOAP) may be used to convey parameters. As to its message format, SOAP relies on Extensible Markup Language (XML). One possible SOAP implementation of a HTTP request and an associated HTTP response transmitted between the UE and the CFIA may look as follows:

```
POST /syncgroup HTTP/1.1
Host: www.etsi.org
Content-Type: application/soap+xml; charset=utf-8
Content-Length: nnn
<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>
  <soap:Body>
    <syncgroupJoinRequest xmlns=“http://www.etsi.org/sync”>
      <syncgroup id=217a5bd0>
        <participant id=“userA@etsi.org” />
      </syncgroup>
    </syncgroupJoinRequest>
  </soap:Body>
</soap:Envelope>
HTTP/1.1 200 OK
Content-Type: application/soap+xml; charset=utf-8
Content-Length: nnn
<?xml version=“1.0” encoding=“utf-8”?>
<soap:Envelope xmlns:xsi=“http://www.w3.org/2001/XMLSchema-
instance” xmlns:xsd=“http://www.w3.org/2001/XMLSchema”
xmlns:soap=“http://schemas.xmlsoap.org/soap/envelope/”>
  <soap:Body>
    <syncgroupJoinResponse xmlns=“http://www.etsi.org/sync”>
      <syncgroup id=“217a5bd0”>
        <participant id=“userA@etsi.org” />
        <rtcp ssrc=“AF” recv=“192.168.1.100:1234” />
      </syncgroup>
    </syncgroupJoinResponse>
  </soap:Body>
</soap:Envelope>
```

In yet another embodiment, the parameters are conveyed by an SDP body in a similar way as used in the case of SIP. In that case, a possible SDP implementation of a HTTP request and an associated HTTP response transmitted between the UE and the CFIA may look as follows:

GET /syncgroup/217a5bd0 HTTP/1.1
Host: www.etsi.org
Accept: application/sdp
HTTP/1.0 200 OK
Content-Type: application/sdp
v=0
o=− 2890844526 2890842807 IN IP4 192.16.24.202
a=ssrc:<ssrc-id> <attribute>:<value>.
a=rtcp-xr:sync-group=<value>
a=rtcp:port [nettype space addrtype space connection-address]

Hence, HTTP provides a very flexible way of conveying parameters, in particular synchronization parameters, between the UE, the CFIA and the MF. Further, HTTP allows further flexibility in the sense that, in further variants, the HTTP PUT (or POST) and the HTTP DELETE messages may allow UEs to join or leave an existing sync group. One embodiment of joining an existing Sync Group may look like:

```
PUT http://cfia.etsi.org/syncgroups/217a5bd0/participants
HTTP/1.1
User-Agent: IPTVClient/1.0
Content-Type: application/vnd.etsi.iptvsyncgroup+xml
Content-Length: 35
<?xml version=“1.0” ?>
<syncgroup id=“217a5bd0”>
  <participant id=“userB@etsi.org” />
</syncgroup>
HTTP/1.1 201 Created
Server: CFIA/1.0
Location: http://cfia.etsi.org/syncgroups/217a5bd0
Content-Type: application/vnd.etsi.iptvsyncgroup+xml
Content-Length: 35
<?xml version=“1.0” ?>
<syncgroup id=“217a5bd0”>
  <participant id=“userA@etsi.org” />
  <participant id=“userB@etsi.org” />
  <rtcp ssrc=“AF” recv=“192.168.1.100:1234” />
</syncgroup>
```

In this embodiment, a UE may send a HTTP PUT message requesting the CFIA to add userB@etsi.org to the Sync Group 217a5bd0. In return, the UE receives an acknowledgement of the CFIA that the UE is added. Further, the response message comprises information regarding the SSRC and the address of the MSAS associated with the Synch Group. Optionally, the response message may contain further information, e.g. the participants in the Sync Group which in this case are identified as userA@etsi.org and userB@etsi.org.

Leaving an existing Sync Group may implemented by sending a HTTP DELETE message DELETE http://msas.etsi.org/syncgroup/217a5bd0/participants/userA@etsi.org HTTP/1.1, User-Agent: IPTVClient/1.0 to the CFIA.

In a similar way, a new Sync Group may be created by sensing a HTTP POST message to the CFIA:

```
POST http://cfia.etsi.org/syncgroups HTTP/1.1
User-Agent: IPTVClient/1.0
Content-Type: application/vnd.etsi.iptvsyncgroup+xml
Content-Length: 35
<?xml version=“1.0” ?>
<syncgroup>
  <participant id=“userA@etsi.org” />
</syncgroup>
HTTP/1.1 201 Created
Server: CFIA/1.0
Location: http://cfia.etsi.org/syncgroups/217a5bd0
Content-Type: application/vnd.etsi.iptvsyncgroup+xml
Content-Length: 35
<syncgroup id=“217a5bd0”>
  <participant id=“userA@etsi.org” />
  <rtcp ssrc=“AF” recv=“192.168.1.100:1234” />
</syncgroup>
```

Embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. Method of dynamically relaying messages of a first protocol for providing control and management information about media streams, the messages being associated with one or more second protocol based multimedia streams, the second protocol being arranged for streaming multimedia data over IP-based networks, each stream being associated with a media session and with a sender node and one or more receiver nodes, the method comprising the steps of:
assigning at least one control node to at least one stream;
providing a receiver node associated with said stream with the address of said control node, said address being provided to said receiver node in a session control protocol message or an HTTP message and being different than the address of the associated sender node; and
said receiver node sending receiver messages of the first protocol to said control node, using said address comprised in said session control protocol message or HTTP message.

2. Method according to claim 1, wherein the first protocol is RTCP, the second protocol is RIP, and the streams are RIP streams.

3. Method according to claim 2, said method further comprising the step of:
providing a group synchronization identifier associated with said RIP stream to said receiver node; and
sending said group synchronization identifier in a receiver RTCP message to said control node.

4. Method according to claim 2, wherein said method further comprises the step of:
said receiver node generating synchronization status information;
sending said synchronization status information in a sender RTCP message to said control node, said control node comprising a synchronization function for synchronizing the RIP stream associated with said sender RTCP message with one or more other RIP streams assigned to said control node.

5. Method according to claim 4, said method further comprising the steps of:
said synchronization function using said synchronization status information to calculate synchronization settings information;
said control node sending said synchronization settings information to said receiver node,
said receiver node using said synchronization settings information to instruct a delay buffer associated with said receiver node.

6. Method according to claim 2, said method further comprising the steps of:
providing said sender node associated with said RIP stream with the address of said control node, said address being provided to said sender node in a session control protocol message; and
said sender node sending sender RTCP messages to said control node, using said address comprised in said session control protocol message.

7. Method according to claim 6, said method further comprising the steps of:
the control node receiving one or more receiver RTCP messages and one or more sender RTCP messages and associating a receiving RTCP message with a sender RTCP when the RIP session identifier, preferably the SSRC, in said RTCP messages are identical; and
the control node sending a receiver RTCP message to the address from which an associated sender RTCP message originates and/or sending a sender RTCP message to the address from which an associated receiver RTCP message originates.

8. Method according to claim 7, wherein at least one of said receiver RTCP messages comprises synchronization status information, said method further comprises the steps of:
removing said synchronization status information from said receiver RTCP message; and
sending said receiver control message to said associated sender node.

9. Method according to claim 7, wherein said method further comprises the steps of:
said synchronization function providing synchronization settings information; and
sending said synchronization settings information in a sender RTCP message to said receiver node.

10. Method according to claim 2, the method further comprising the step of:
at least one sender node multicasting at least one of said RIP streams and associated sender RTCP messages to one or more receiver nodes.

11. Method according claim 10, the method further comprising the step of:
the receiver node sending at least one of said RTCP messages to said control node.

12. Method according claim 10, the method comprising the steps of:
sending a request for the control node to join the member group associated with said multicast or providing an unicast connection between the sender node and the control node for providing sender RTCP messages to said control node.

13. Method according claim 10, the method comprising the steps of:
the control node receiving one or more receiver RTCP messages and one or more sender RTCP messages and associating a receiving RTCP message with a sender RTCP when the RIP session identifier, preferably the SSRC, in said RTCP messages are identical; and
the control node sending a receiver RTCP message to the address from which an associated sender RTCP message originates and/or sending a sender RTCP message to the address from which an associated receiver RTCP message originates.

14. A system for dynamically relaying messages of a first protocol for providing control and management information about media streams, the system comprising:
a control node for receiving one or more of receiver messages of the first protocol generated by one or more receiver nodes and/or sender messages of the first protocol generated by one or more sender nodes;
a relay control function associated with said control node, said control function being configured to provide a receiver node and/or sender node associated with a second protocol based multimedia stream, with the address of said control node, said address being provided to said receiver and/or sender node in a session control protocol message or an HTTP message, said second protocol being arranged for streaming multimedia data over IP-based networks; and
at least one receiver node configured to send messages of the first protocol to said control node, using said address comprised in said session control protocol message or an HTTP message.

15. System according to claim 14, wherein the first protocol is RTCP, the second protocol is RIP, and the streams are RIP streams.

16. A system according to claim 15, the system further comprising:
at least one sender node configured to send RTCP messages to said control node, using said address comprised in said session control protocol message or HTTP message;
wherein said control node further comprises:
at least one input for receiving receiver RTCP messages originating from one or more receiver nodes and/or sender RTCP messages originating from one or more sender nodes;
a mapping function for associating a receiving RTCP message with a sender RTCP when the RIP session identifier, preferably the SSRC, in said RTCP messages are identical; and
at least one output for sending a receiver RTCP message to the address from which an associated sender RTCP message originates and/or sending a sender RTCP message to the address from which an associated receiver RTCP message originates.

17. A receiver node configured for use in the system according to claim 15, the receiver node configured for receiving a session control protocol message or an HTTP message comprising the address of a control node and for sending receiver RTCP messages generated by said receiver node to said control node, using said address comprised in said session control protocol message, the receiver node further comprising:
a sync client configured for generating synchronization status information, for inserting said synchronization status information in a receiver RTCP message and sending said receiver RTCP message to said control node.

18. A control node for use in a system according to claim 15, the control node comprising:
at least an input for receiving receiver RTCP messages originating from one or more receiver nodes and/or sender RTCP messages originating from one or more sender nodes;
a mapping function for associating a receiving RTCP message with a sender RTCP when the RIP session identifier, preferably the SSRC, in said RTCP messages are identical;
at least one output for sending a receiver RTCP message to the address from which an associated sender RTCP message originates and/or sending a sender RTCP message to the address from which an associated receiver RTCP message originates; and, optionally,
a sync function configured for receiving synchronization status information sent by one or more receiver nodes in one or more receiver RTCP messages to said control node and for calculating on the basis of said synchronization status information synchronization settings information for said one or more receiver nodes, said synchronization settings information allowing the one or more receiver nodes to time-delay at least one RIP stream,
wherein the control node is configured for use in the system according to claim 15.

19. A computer program product comprising software code portions configured for, when run in the memory of one or more sender-, receiver- and/or control nodes, executing the method steps according to claim 1.
